(19) United States
(12) Patent Application Publication
(10) Pub. No.: US 2023/0366684 A1
(43) Pub. Date: Nov. 16, 2023

(54) MULTIPOINT ROUTING & DISTRIBUTION OF SEARCH RESULTS ALONG ROUTE

(71) Applicant: Apple Inc., Cupertino, CA (US)

(72) Inventors: Dennis Schieferdecker, Cupertino, CA (US); Francimar C. Schmitt, Santa Clara, CA (US); Ishan Bhutani, Sunnyvale, CA (US); Christian West, Sunnyvale, CA (US)

(73) Assignee: Apple Inc., Cupertino, CA (US)

(21) Appl. No.: 18/100,887

(22) Filed: Jan. 24, 2023

Related U.S. Application Data
(60) Provisional application No. 63/364,490, filed on May 10, 2022.

(51) Int. Cl. G01C 21/34; G06F 16/9537; G06F 16/9535; G06F 16/2457; G01C 21/36

(52) U.S. Cl. CPC G01C 21/343; G01C 21/3667; G06F 16/24578; G06F 16/9535; G06F 16/9537

(57) ABSTRACT

Multipoint routing through the use of a navigation device can be improved by using multipoint arrival and departure detection to determine whether to advance navigation to a next point on the route or to maintain navigation to a current point on the route. When adding intermediate points to a route, the locations generated by the search query can include a spatiotemporal distribution of search results. The results of the search can also be presented with routing cost information.

### CROSS-REFERENCES TO RELATED APPLICATIONS

This application claims priority to U.S. Provisional Pat. Application No. 63/364,490, entitled “MULTIPOINT ROUTING & DISTRIBUTION OF SEARCH RESULTS ALONG ROUTE,” filed on May 10, 2022, the contents of which are hereby incorporated by reference in their entirety for all purposes.

### BACKGROUND

With the proliferation of mobile devices, electronic maps are used by a variety of services and applications. Some uses for electronic maps can include travel directions (such as for driving, walking, etc.) or for presenting information related to specific geographic locations. Electronic maps can be used for generating routes and guiding users along routes.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method includes maintaining, by a user device, navigation to a first intermediate waypoint, the first intermediate waypoint corresponding to a multi-waypoint route on a map, the multi-waypoint route having one or more intermediate waypoints and a destination. The computer-implemented method also includes determining, by the user device, whether the user device is within a zone corresponding to the first intermediate waypoint of the multi-waypoint route. The computer-implemented method also includes in response to determining that the user device is within the zone corresponding to the first intermediate waypoint, identifying a set of locations of the user device, each location of the set of locations identified at least periodically by the user device. The computer-implemented method also includes determining, by the user device, a set of weights for the locations, each weight of the set of weights corresponding to a location of the set of locations, and each weight being based at least in part on a time since the respective locations were identified. The computer-implemented method also includes determining, by the user device, a departure score based at least in part on the set of weights and the set of locations. The computer-implemented method also includes updating the multi-waypoint route on the map based at least in part on the departure score. Other embodiments of this aspect include corresponding computer systems, apparatus, and computer programs recorded on one or more computer storage devices, each configured to perform the actions of the methods.

Another general aspect includes a computer-implemented method. The computer-implemented method includes receiving, by a computing device, a search query during presentation of a route associated with a map, the search query configured to be used to determine one or more associated locations on the map, and the route configured with one or more sets of bounding boxes associated with points on the route. The computer-implemented method also includes determining, by the computing device, locations on the map associated with the search query, the locations being within a first set of bounding boxes of the one or more sets of bounding boxes along the route. The computer-implemented method also includes receiving, by the computing device, routing cost information associated with each location of the locations from a routing server. The computer-implemented method also includes generating, by the computing device, a distribution of the locations based at least in part on the routing cost information, the distribution configured to include a subset of locations that are distributed across a threshold portion of the route. The computer-implemented method also includes displaying, by the computing device, at least part of the subset of the locations on a user interface of the computing device according to the distribution. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 illustrates a simplified flow diagram for performing the techniques described herein, according to an embodiment of the present disclosure.

FIG. 2 illustrates a block diagram for illustrating the techniques described herein, according to an embodiment of the present disclosure.

FIG. 3 illustrates a block diagram for illustrating the techniques described herein, according to an embodiment of the present disclosure.

FIG. 4 illustrates a block diagram for illustrating the techniques described herein, according to an embodiment of the present disclosure.

FIG. 5 illustrates a simplified flow diagram for performing the techniques described herein, according to an embodiment of the present disclosure.

FIGS. 6A, 6B, and 6C illustrate diagrams for describing the techniques described herein, according to an embodiment of the present disclosure.

FIG. 7 illustrates a simplified flow diagram for performing the techniques described herein, according to an embodiment of the present disclosure.

FIG. 8 illustrates an example architecture or environment configured to implement the techniques described herein, according to an embodiment of the present disclosure.

### DETAILED DESCRIPTION OF THE INVENTION

Certain embodiments of the present disclosure relate to devices, computer-readable medium, and methods for implementing various techniques for various features of multipoint routing. In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Maps are used for many applications. A map engine allows the use of a map system by other client applications. For example, electronic maps are used on personal devices for many different functions. One particular function or application for electronic maps is for routing to a target location. However, a user may want to create a route between multiple points rather than having a single origin and destination. A route with multiple waypoints along the way can be referred to as a multipoint route. A multipoint route can have an origin, one or more intermediate waypoints, and a destination. An origin can also be referred to as a starting point or starting location. A destination can also be referred to as an end point, ending point, or end location.

There are several ways to develop a multipoint route. A multipoint route can be determined at the beginning of the route. For example, a user may enter a starting location (for example, their current location), and one or more intermediate locations before entering an end location before embarking on the route. A multipoint route can also be created from a single point route where there is only an origin and destination. For example, a user may be enroute from the origin to the destination but need to add and/or travel to one or more intermediate locations before arriving at the destination. Similarly, a waypoint could be added after the destination such that the new waypoint could be considered the destination and the former destination can be considered an intermediate location. In this way, a multipoint route is generated from a single point route.

Examples of the present disclosure are directed to, among other things, methods, systems, devices, and computer-readable media for multipoint routing arrival and departure detection. Multipoint routing arrival and departure detection can be useful by continuing routing navigation, for example by giving auditory indications, if the user is detected to be continuing on their route to another intermediate point or to the destination. Similarly, multipoint routing arrival and departure detection can be useful by maintaining routing navigation to the current intermediate waypoint if the user is detected to be stopping at the intermediate waypoint or trying to find a stop location or parking location near the intermediate waypoint. The map engine’s detection of multipoint routing arrival and departure will enable the map engine, and/or the client application using the map engine, to provide the correct navigation information to the user (based on of the user’s actions or inferred intent).

Turning now to a first particular example, in this example is provided a portable user device that includes a map engine and a client application configured for multipoint routing. The map engine may support mapping services on the portable user device, which may include providing a map view within the client application and implementing techniques relating to multipoint routing. The client application may be a third-party application that uses the map engine to perform map-related functions. Alternatively, the client application can be a first-party application that uses the map engine to perform map-related functions. For example, the client application may be a map application that uses the map engine to determine and present routes that may include a destination and one or more intermediate waypoints. The map engine can also be configured for automatic detection of arrival or departure from an intermediate waypoint.

In this first example, the map engine can be configured to automatically detect arrival at the intermediate waypoint. The map engine may have a pre-arrival zone associated with the intermediate waypoint. The pre-arrival zone can be determined in multiple ways based on the information surrounding the intermediate waypoint. The pre-arrival zone can be related to one or more entrances to the intermediate waypoint or with a parking lot associated with the intermediate waypoint.

In this first example, when arriving at a pre-arrival zone associated with an intermediate waypoint, a user of the portable user device including the map engine has several options. For example, among other options, the user could a) proceed to the next intermediate waypoint or to the destination, b) stop at the intermediate waypoint or nearby, or c) look for a place to store and/or park their vehicle. Alternatively, the user could recover from getting lost (e.g., if they missed a routing instruction and passed the waypoint). The map engine is configured to be able to automatically detect which option the user is choosing based on a periodic determination of the location of the portable user device and/or time spent trying to reach the waypoint. The map engine can update the client application to reflect the user’s decision and/or intent regarding the intermediate waypoint.

In this first example, a departure score may be calculated based on the periodic determination of the location of the portable user device. Multiple other factors can also influence the departure score. For example, the departure score may weigh the most recent locations higher than previous locations. The departure score can be used to determine the user’s intent. For example, if the map engine determines that the location of the portable device is along the route to the next intermediate waypoint or to the final destination, then the map engine can determine that the user’s intent is to continue along the multipoint route. If the map engine determines that the location of the portable device is approaching, staying nearby, or looping back around on the route, the map engine can determine that the user’s intent is to continue navigation to the present intermediate waypoint (e.g., the user is looking for parking or is lost).

In another example, the map engine may provide spatio-temporal distribution of search results along a map. As described above, a user may already be along a route or a multipoint route when they want to look for a new intermediate waypoint. For example, the user may be on a road trip, and they decide they want to find coffee. The user can enter a search query into their user device and the user device (whether the client application or the map engine) can send the search query to a map server. The map server can determine user intent from the search query and determine whether the user is looking for nearby locations, locations along the route, or a specific location. The map server will then determine a list of locations that are within one or more bounding boxes of the route and the current location of the user. The map server can then provide the list of locations to the routing server to determine routing cost and routing information. The routing server will provide the routing cost and routing information for each location on the list to the map server. The map server can then send the list of locations with associated routing cost and routing information to the user device.

In this second example, if the search query is indicative of intent to look for locations along a route, the map server can divide the route up into segments where some segments are closer to the user device and others are farther away. Because the computational and network costs of determining routing information for every possible location are significant, the map server can provide the routing server with a list of locations that may be a subset of all possible locations matching the search query (e.g., instead of providing the entire list). That subset of locations can include results in each segment of the route. The routing server can determine routing costs and routing information for the subset of locations and send the results back to the map server. In this way, the map server has a list of results with locations and routing cost information to send to the user device.

In this second example, when the list of locations and associated routing cost and routing information is presented at the user device, it can be sorted based on the routing cost. In this way, a location matching the search query which is relatively far away but has a low routing cost can be ranked higher than a location relatively close but with a higher routing cost. Multiple factors can determine how locations are ranked in response to the search query.

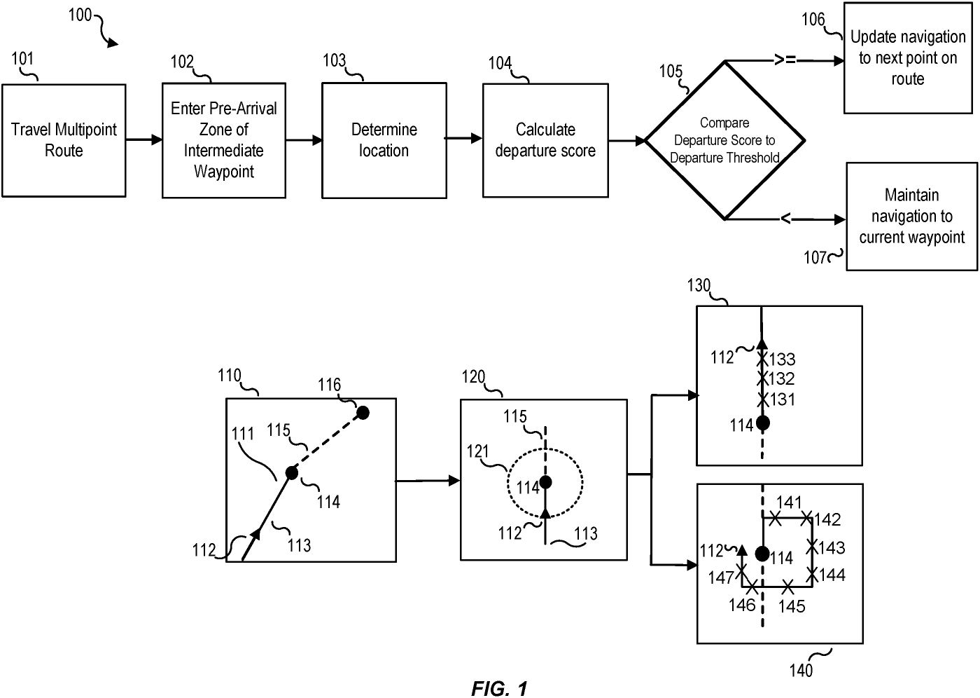

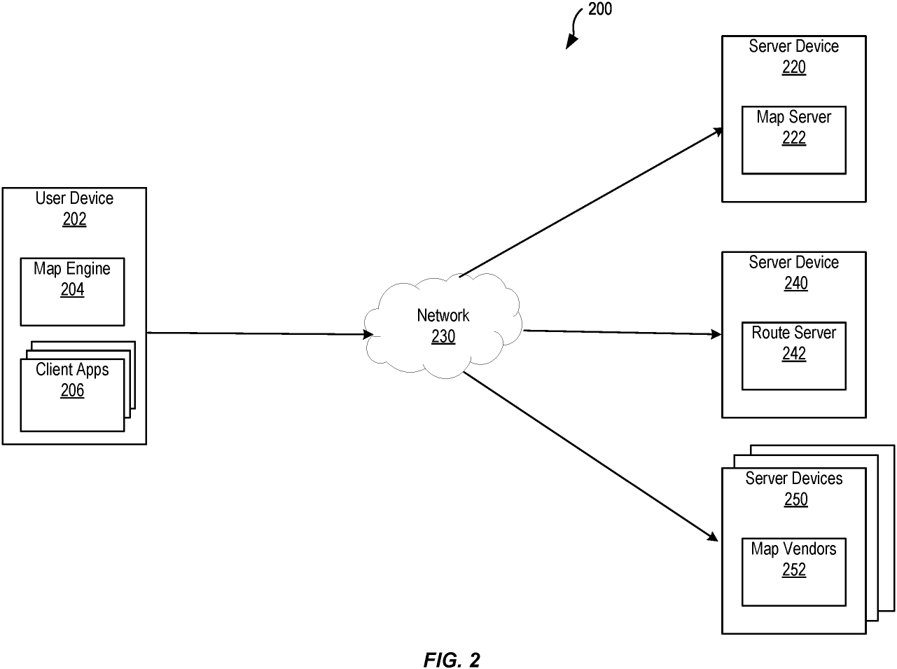

FIG. 1 illustrates a block diagram and a flowchart showing a process 100 for multipoint arrival and departure detection, according to at least one example. For example, with reference to FIG. 2, process 100 can be performed by the map server 222, the route server 242 or can be performed by the map engine 204 or a client application 206 on the user device 202. Alternatively, process 100 could be performed by any combination of the following: the map server 222, the route server 242, the map engine 204 on the user device 202, or a client application 206 on the user device 202. For example, part of the process 100 can be performed by the map server 222 and part of the process 100 can be performed by the map engine 204 on the user device 202. Process 100 provides a high-level overview of how multipoint arrival and departure detection can operate. Below process 100 can be described as being performed on the user device 202, but as described above the map server 222, the route server 242, the map engine 204 on the user device 202 or a client application 206 on the user device 202 can perform all or parts of process 100 as well.

Process 100 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 101, the user device can navigate or present navigation of a multipoint route. Block 110 illustrates an example multipoint route 111 being traveled by a user 112. The multipoint route can have one or more intermediate waypoints and a destination. The multipoint route 111 can have an intermediate waypoint 114 and a destination 116. The multipoint route can include legs of a route which are the routes from one intermediate waypoint to another intermediate waypoint or from an intermediate waypoint to the destination. Route leg 113 can represent the current navigation to the intermediate waypoint 114. Route leg 115 can represent future navigation from the intermediate waypoint 114 to the destination 116. The user device maintains the navigation of the multipoint route.

At block 102, the user device can detect that it has entered a pre-arrival zone associated with the intermediate waypoint. Block 120 illustrates an example arrival by the user 112 at a pre-arrival zone 121 associated with the intermediate waypoint 114.

The pre-arrival zone 112 can be determined in multiple ways. In some implementations, the pre-arrival zone 112 can be a region that the user device receives from a server. In some implementations, the pre-arrival zone can be calculated. In some implementations, the pre-arrival zone 112 can be an area associated with the intermediate waypoint 114. The area can be defined using road network topology and other area properties. For example, a road network topology can apply a designation to an area. Area properties can be used to describe attributes or purposes for a specific area. For example, an area property of an area can be that the area is a parking lot. In some implementations, the pre-arrival zone 112 can be defined as a certain distance or travel time from an area associated with the intermediate waypoint 114. For example, the pre-arrival zone 112 can be defined as within a certain distance of a parking lot, for example, within 100 meters of a parking lot. The pre-arrival zone 112 can be associated with one or more entrances to the location represented by the intermediate waypoint 114. The pre-arrival zone 112 can be defined as within a certain distance of the one or more entrances to the location represented by the intermediate waypoint 114. For example, the intermediate waypoint 114 could be associated with the location of a mall. The mall can have multiple entrances such that the pre-arrival zone can be any location within a distance from any of the multiple entrances. The pre-arrival zone 112 can be defined as being within a certain time of travel from the intermediate waypoint 114. In some implementations, the pre-arrival zone can be defined by a distance or travel time in relation to the intermediate waypoint 114 or an associated area with the intermediate waypoint 114. The pre-arrival zone 112 can include any combination of the above descriptions of example pre-arrival zones.

At block 103, the location of the user device is determined periodically once the user device has entered the pre-arrival zone. The locations are stored to create a set of locations. The set of locations can also be referred to as previous locations or the set of previous locations. The period for determining the location of the user device can be any reasonable amount of time. The period for determining the location of the user device can have a range between 0.1 seconds to 10 seconds. The period can be 1 second, 2 seconds, 3 seconds, 4, seconds, 5 seconds, 6 seconds, 7 seconds, 8 seconds, 9 seconds, or 10 seconds. Alternatively, the period can be 0.1 seconds, 0.2 seconds, 0.3 seconds, 0.4 seconds, 0.5 seconds, 0.6 seconds, 0.7 seconds, 0.8 seconds, or 0.9 seconds.

In some implementations, only a set number of locations are stored. For example, only the last ten locations may be stored. The number of locations to be stored can be any reasonable number of locations. For example, the number of locations to be stored can be 2-1000, or even more.

At block 104, a departure score is calculated based at least in part on the set of locations determined periodically. The departure score can be calculated periodically as well. In some implementations, the period for calculating the departure score can be synced with the period for determining location of the user device. In some implementations, the period for calculating the departure score can be different from the period for determining location of the user device. The period for calculating the departure score can have a range between 0.1 seconds to 10 seconds. The period can be 1 second, 2 seconds, 3 seconds, 4, seconds, 5 seconds, 6 seconds, 7 seconds, 8 seconds, 9 seconds, or 10 seconds. Alternatively, the period can be 0.1 seconds, 0.2 seconds, 0.3 seconds, 0.4 seconds, 0.5 seconds, 0.6 seconds, 0.7 seconds, 0.8 seconds, or 0.9 seconds.

There are a variety of ways to calculate the departure score. Any combination of the following factors can be used to calculate the departure score. The departure score can be calculated based at least in part on the number of previous locations inside the pre-arrival zone. The departure score can be calculated based at least in part on a ratio of number of previous locations inside the pre-arrival zone. The departure score can be calculated based at least in part on the number of previous locations outside the pre-arrival zone. The departure score can logarithmically weight previous locations starting from the most recent previous location. The departure score can be calculated based at least in part on the distance from the previous locations to the intermediate waypoint. The departure score can be calculated based at least in part on the distance from the previous locations to an entryway of the location associated with the waypoint. The departure score can be calculated based at least in part on the distance from the previous locations to a parking lot associated with the waypoint. The departure score can be calculated based at least in part on a ratio of previous locations’ distances from the waypoint compared to the closest distance the user device has come to the waypoint. The departure score can be calculated based at least in part on time spent within the pre-arrival zone. The departure score can be calculated based at least in part on the number of re-routes the client application or map engine has had to make once entering the pre-arrival zone. The departure score can be calculated based at least in part on an auto-advance tendency factor which is controlled by the user, user device, map server, map engine, and/or client application.

Block 130 provides an example of a set of previous locations that could be indicative of the user’s intent to continue along the route. Location 131 can represent the location of the user device three periods ago. Location 132 can represent the location of the user device two periods ago. Location 133 can represent the location of the user device at the end of the previous period. A departure score can be calculated based at least in part on these locations according to the methods described above. Once the map engine determines a departure score and compares it to a departure threshold, the map engine can determine that the user intends to continue along the next leg of the multipoint route.

Block 140 provides an example of a set of previous locations that could be indicative of the user’s intent to maintain navigation to the intermediate waypoint 114. Locations 141, 142, 143, 144, 145, 146, and 147 are all previous locations of the user device at the end of the seven previous periods. A departure score can be calculated based at least in part on these locations according to the methods described above. Once the map engine determines a departure score and compares it to a departure threshold, the map engine can determine that the user intends to maintain navigation to the intermediate waypoint.

At block 105, the user device can determine whether the user intends to advance navigation to the next leg of the multipoint route (e.g. advance navigation to the next intermediate waypoint or the destination) or whether the user intends to maintain navigation to the intermediate waypoint 114. This determination is based at least in part on the departure score in relation to a departure threshold. In some implementations, the departure score being above the departure threshold is indicative of a departure. In some implementations, the departure score being above or equal to the departure threshold can be indicative of updating navigation to the next waypoint or leg of the multipoint route, for example at block 106. Updating navigation to the next waypoint or leg of the multipoint route can also be considered continuing along the multipoint route. In some implementations, the departure score being below the departure threshold can be indicative of maintaining navigation to the present intermediate waypoint, for example at block 107. This example implementation is illustrated in FIG. 1 at blocks 105, 106, and 107.

Alternatively (and not illustrated in FIG. 1), the departure score being above the departure threshold can be indicative of maintaining navigation to the present intermediate waypoint. In some implementations, the departure score being below or equal to the departure threshold can be indicative of a continuing to the next leg of the multipoint route.

In some implementations, at block 105, the user device can determine to pause navigation until some future point (not illustrated in FIG. 1). The user device can determine to pause navigation based at least on the departure score in relation to a departure threshold. The user device can also determine to pause navigation based at least in part on an indication to pause, for example a user input to pause navigation. If the user device 202 receives an indication to pause navigation then the navigation will paused such that the multipoint route is stored until there is an indication to resume navigation.

In some implementations, at block 105, the user device can determine to resume navigation after navigation has been paused (not illustrated in FIG. 1). If a user device 202 receives an indication to resume navigation, navigation resumes to the previous point when navigation was paused. For example, if the user device 202 was navigating to intermediate waypoint 114 when navigation was paused, when navigation is resumed the user device 202 will resume navigation to intermediate waypoint 114. An example indication to resume navigation can be a user input to resume navigation. In other implementations, the determination to resume navigation can be based at least in part on the departure score in relation to a departure threshold. The calculation of a departure score while navigation is paused can be periodic. The period for calculating a departure score while navigation is paused can be less than, equal to, or greater than the period for calculating a departure score while navigation is active (for example, when navigation is resumed).

In some implementations, at block 105, the user device can determine to simultaneously present the user with a) maintained navigation to the intermediate waypoint 114 and b) advanced navigation to the next point on the route. The user device 202 can then receive an indication on whether to maintain navigation to the intermediate waypoint 114 or advance navigation to the next point on the route. For example, such an indication could be a user input on the user device. In some implementations, the simultaneous presentation of both a maintained navigation to the intermediate waypoint 114 and advanced navigation to the next point on the route can be presented when the user device 202 detects that the user device 202 has diverged from a current route (for example, the maintained navigation to the intermediate waypoint 114 and/or the advanced navigation to the next point on the route) and the user device 202 has received rerouting information for present navigation. The rerouting information can be related to either the maintained navigation to the intermediate waypoint 114 or the advanced navigation to the next point on the route.

FIG. 2 is a block diagram of an example system 200 for generating maps and routing based on map data and routing data obtained from different sources. For example, system 200 can be configured to obtain map data and routing data from different sources (for example, map server, route server, map data vendors), stitch the map data from the different sources together, and generate a map that represents the map data and route data received from the various sources. When stitching together the map data and route data, system 200 can make adjustments to the map data to avoid errors, discrepancies, and map appearance problems, as described in detail below.

In some implementations, system 200 can include user device 202. For example, user device 202 can be a computing device such as a laptop computer, desktop computer, smartphone, wearable device (for example, smartwatch, smart glasses, etc.), an in-vehicle infotainment system, and/or other computing device. User device 202 can include a built-in display and/or may be connected to an external display (for example, television, computer monitor, in-car system, smart glasses, etc.) using a wired and/or wireless connection. User device 202 can present graphical user interfaces generated by various software components (for example, operating system, user-level applications, etc.) installed and/or running on user device 202 on the built-in display and/or the connected external display.

In some implementations, user device 202 can include a map engine 204. The map engine 204 can enable client applications 206 on the user device 202 to access the map data and route data received through the system 200. The map engine 204 can also process map-related data, for example as provided by a map vendor 252 or a map server 222. The map engine can also process route-related data, for example as provided by a route server 242. In some implementations, client applications 206 can obtain map data from a map server to present the various types of maps and/or map data. Client applications 206 can then process the map data received from the map server to generate the graphical user interfaces presented on the display of user device 202. For example, client applications 206 can obtain the map data from map server 222 running on server device 220 through network 230 (for example, a local area network, wide area network, wireless network, cellular data network, the Internet, etc.).

In some implementations, the user device may have client applications 206 that access map data through the map engine 204. For example, a navigation application for providing directions can be one of the client applications 206. Client applications 206 can generate and/or present graphical user interfaces for presenting map data on a display (for example, built-in, external, etc.) of user device 202. Client applications 206 can present various types of maps that represent various types of map data. For example, client applications 206 can present maps that represent elevation, vegetation, coastlines, landcover, precipitation, and/or other data, as may be described herein. An example client application could be a navigation application. A navigation application can provide graphical user interfaces that allow the user to specify route parameters (for example, start location, destination location, transportation mode, etc.) and request navigation instructions based on the specified route parameters. A navigation application can present recommended routes based on the user specified route parameters and present navigation instructions for a route selected by the user. In some implementations, the client applications 206 receive the route information from the route server 242 directly.

In some implementations, system 200 can include server device 220. For example, server device 220 can be a computing device configured to host map server 222. Map server 222 can be a software server, or collection of software servers, configured to generate map data, maps, routing data, and/or routes for client devices (for example, user device 202) and/or client applications 206.

In some implementations, map server 222 can obtain map data from various map data vendors. For example, different map data vendors may specialize in different types of map data. For example, various, different map vendors may specialize in and/or provide high quality terrain elevation data, marine elevation data, climate data, land cover data, etc. For example, the map server 222 can receive route information from the route server 242. Thus, map server 222 may obtain different types of map data from different sources or vendors. Map server 222 can combine the different types of map data received from different map vendors into a combined map data that can be served to client apps 206 or map engine 204 on user device 202.

In some implementations, system 200 can include server device 240. For example, server device 240 can be a computing device connected to network 230. Server device 240 be configured to communicate with server device 220 through network 230 to deliver route data to server device 220. For example, server device 240 can include route server 242 (for example, software servers) that process vendor map data and serve the route data to map server 222 on server device 220.

In some implementations, system 200 can include server devices 250. For example, server devices 250 can be computing devices connected to network 230. Server devices 250 be configured to communicate with server device 220 through network 230 to deliver map vendor data to server device 220. For example, server devices 250 can include map vendors 252 which can serve as servers (for example, software servers) that process vendor map data and serve the vendor map data to map server 222 on server device 220. One of map vendors 252 can, for example, manage and serve terrain elevation map data to map server 222, while another one of map vendors 252 may manage and serve land cover data (for example, vegetation, forest, urban shrubland, etc.) to map server 222. One map vendor 252 can be associated with a different type of vendor map data than another map vendor 252. In some implementations, one map vendor 252 can be associated with the same type of vendor map data as another map vendor 252. Map vendors 252 can manage and serve any type of map data, including the various types of map data as may be described herein. In some implementations, route server 242 can be a one of the map vendors 252.

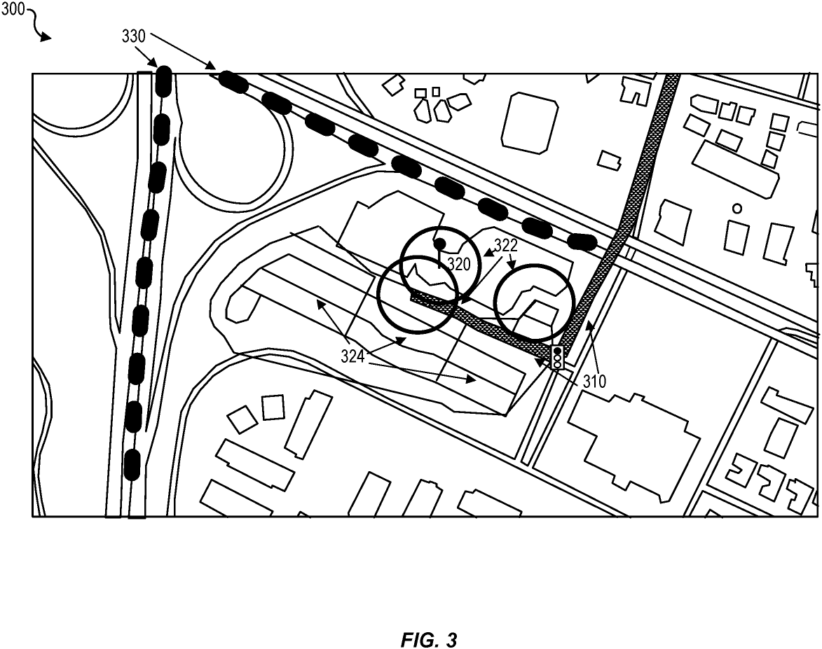

FIG. 3 illustrates an example map 300 which has portions of a multipoint route charted thereon. The multipoint route has the present route leg 310 to intermediate waypoint 320 and future route leg 330. The example map 200 also has a parking lot 324 and multiple entrances with circles 322 denoting a radial distance around the entrances.

In some implementations, the present route leg 310 to the intermediate waypoint 320 and the future route leg 330 are displayed on the user device. The present route leg 310 and the future route leg 330 can be differentiated, for example by being in a different color, opacity, or marked with a different pattern.

With reference to block 102 of FIG. 1, example map 300 has several examples of pre-arrival zones for the intermediate waypoint 320 that can trigger the determination of location and calculation of departure scores. As described above, the parking lot 324 can be designated as a pre-arrival zone. In some implementations, the parking lot 324 can be used as a center point for a pre-arrival zone with a distance from the center point defining the pre-arrival zone. Circles 322 which denote a radial distance around the entrances to the location associated with waypoint 320 can also be designated as pre-arrival zones. In this example, circles 322 would denote relatively small pre-arrival zones. In some implementations, both the parking lot 324 and the circles 322 around entrances to the location associated with waypoint 320 can be designated as part of the pre-arrival zone for waypoint 320.

In some implementations, the user interface on the user device 202 presents user interface elements that allow the user to control whether to advance or not advance the multipoint route. Advancing along the multipoint route can also be referred to advancing navigation. In some implementations, these user interface elements can be presented once a user device 202 has entered a pre-arrival zone 121 associated with an intermediate waypoint 114. In some implementations, these user interface elements can be presented after a user device 202 has entered a pre-arrival zone 121 associated with an intermediate waypoint 114 for a certain amount of time or a certain number of location determination periods. For example, one user interface element could be a “proceed to next point” or “continue” user interface element. If the user device 202 receives an indication to “proceed to next point” then the navigation will update to proceed to the next point on the multipoint route.

In another example, one user interface element could be a “maintain current navigation” If the user device 202 receives an indication to “maintain current navigation” then the navigation presented will continue to be navigation to intermediate waypoint 114. In some implementations, if the user device 202 receives an indication to “maintain current navigation” a user interface element can be presented to “proceed to next point” as described above.

In another example, one user interface element could be a “pause navigation” user interface element. If the user device 202 receives an indication to “pause navigation” then the navigation will paused such that the multipoint route is stored until there is an indication to resume navigation. In some implementations, if the user device 202 receives an indication to “pause navigation” a user interface element can be presented to “resume navigation.” If a user device 202 receives an indication to “resume navigation” navigation resumes to the previous point when navigation was paused. For example, if the user device 202 was navigating to intermediate waypoint 114 when navigation was paused, when navigation is resumed the user device 202 will resume navigation to intermediate waypoint 114.

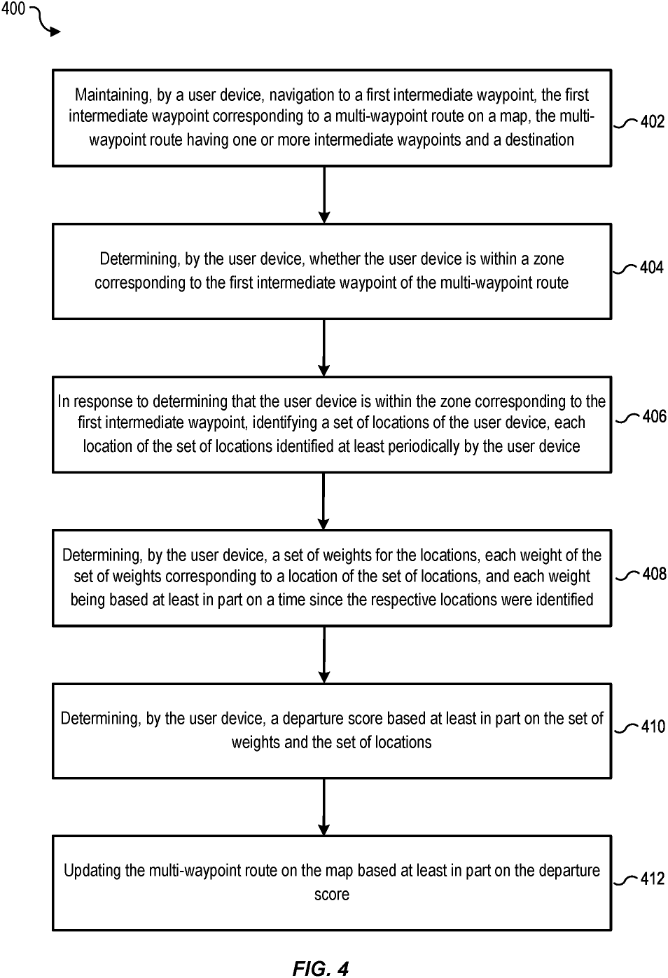

FIG. 4 illustrates a flow chart showing an example process 400 for multipoint route arrival and departure detection, according to at least one example. The process 400 may be performed by the user device 202, the map server 222, or the route server 242. Any part of the process 400 can be performed by the user device 202, the map server 222, or the route server 242. When any part of process 400 is performed on the user device 202, it can be performed by the map engine 204 or by a client application 206. When any part of process 400 is performed on the user device 202, it can be performed by the map engine 204 of the user device 202 in response to requests from client apps 206 for the navigating a route. Below, process 400 can be described as being performed by the user device 202, but as described above the map server 222, the route server 242, the map engine 204 or a client application 206 can perform all or parts of process 400 as well.

Process 400 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The process 400 begins at block 402 by maintaining, by a user device, navigation to a first intermediate waypoint. The first intermediate waypoint can correspond to a multi-waypoint route on a map. The multi-waypoint route can have one or more intermediate waypoints and a destination.

At block 404, process 400 includes determining, by the user device, whether the user device is within a zone. The zone can correspond to the first intermediate waypoint of the multi-waypoint route.

In some examples, the zone can include a parking area associated with the first intermediate waypoint. The zone can include an area within a distance of the first intermediate waypoint. The zone can include an area within a distance of an entry associated with the first intermediate waypoint. The zone can include an area within a distance of one or more entries associated with the first intermediate waypoint. The zone can include any combination of the following: an area within a distance of the first intermediate waypoint, an area within a distance of an entry associated with the first intermediate waypoint, an area within a distance of one or more entries associated with the first intermediate waypoint, and a parking area associated with the first intermediate waypoint.

At block 406, process 400 includes, in response to determining that the user device is within the zone corresponding to the first intermediate waypoint, identifying a set of locations of the user device. Each location of the set of locations can be identified at least periodically by the user device. In some examples, the period for identifying each location of the set of locations is one second. In some examples, the set of locations is limited to a maximum number of locations, an oldest location being replaced by a newest location, for example first-in last-out.

At block 408, process 400 includes determining, by the user device, a set of weights for the locations. Each weight of the set of weights can correspond to a location of the set of locations. Each weight can be based at least in part on a time since the respective locations were identified.

At block 410, process 400 includes determining, by the user device, a departure score based at least in part on the set of weights and the set of locations.

In some examples, the departure score can be based at least in part on any of the following: a number of locations of the set of locations inside the zone, a ratio of a number of locations of the set of locations inside the zone compared to a total number of locations in the set of locations, a number of locations of the set of locations outside the zone, distances of the locations of the set of locations from the zone, distances of the locations of the set of locations from the first intermediate waypoint, distances of the locations of the set of locations from the first intermediate waypoint, an auto-advance tendency factor, or a number of re-routes to the first intermediate waypoint after the user device entered the zone. Each of the above factors in determining the departure score can be weighed equally or differently.

In some examples, the departure score can be based on any combination of the following: a number of locations of the set of locations inside the zone, a ratio of a number of locations of the set of locations inside the zone compared to a total number of locations in the set of locations, a number of locations of the set of locations outside the zone, distances of the locations of the set of locations from the zone, distances of the locations of the set of locations from the first intermediate waypoint, distances of the locations of the set of locations from the first intermediate waypoint, an auto-advance tendency factor, or a number of re-routes to the first intermediate waypoint after the user device entered the zone. Each of the above factors in determining the departure score can be weighed equally or differently.

In some examples, the departure score can be calculated at least periodically.

At block 412, process 400 includes updating the multi-waypoint route on the map based at least in part on the departure score.

In some examples, updating the multi-waypoint route includes maintaining navigation to the first intermediate waypoint based at least in part on the departure score in relation to a departure threshold.

In some examples, wherein updating the multi-waypoint route includes advancing navigation from the first intermediate waypoint to a second intermediate waypoint based at least in part on the departure score in relation to a departure threshold.

In some examples, wherein updating the multi-waypoint route includes advancing navigation from the first intermediate waypoint to the destination based at least in part on the departure score in relation to a departure threshold.

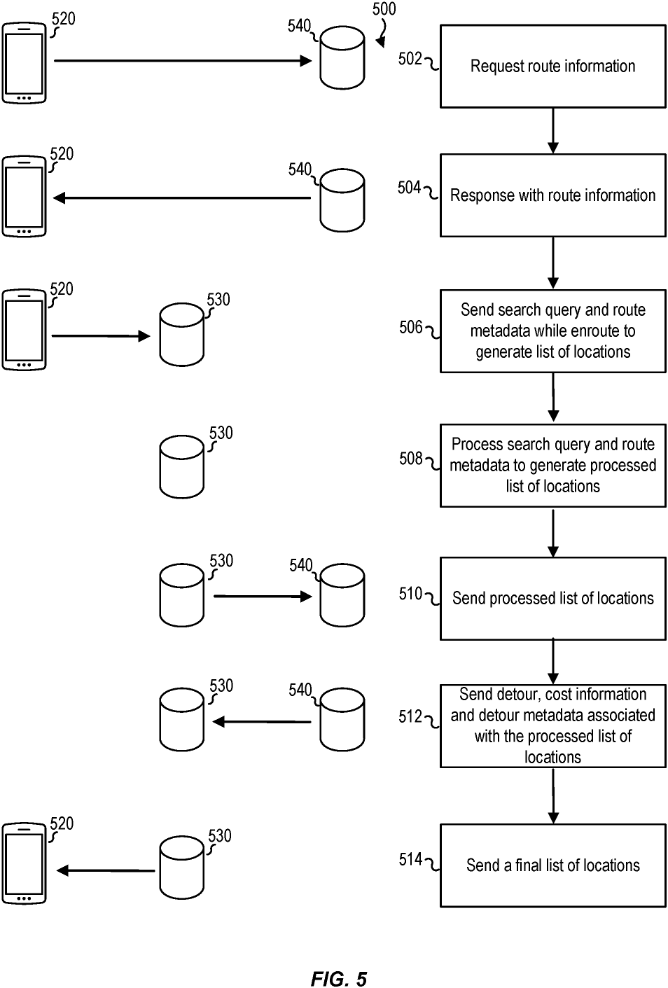

FIG. 5 illustrates a block diagram and a flowchart showing a process 500 for spatio-temporal distribution of search results along a route, according to at least one example. The process 500 can include the use of a user device 520, a map server 530, and a route server 540. The map server 530 and the route server 540 do not have to be on separate devices. In some implementations, the map server 530 and the route server 540 refer to applications and/or services on one or more computing devices.

Parts of the process 500 may be referred to as being performed by the user device 520. Any part of the process 500 that is referred to as being performed by the user device 520 can be performed or implemented by the map engine 204 on the user device 520 or a client application 206 on the user device 520. In some implementations, part of the process being referred to as being performed by the user device 520 can be performed by the map engine 204 while another part of the process being referred to as being performed by the user device 520 can be performed by a client application 206.

Process 500 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At block 502, the user device 520 can request route information from a route server 540 to a target destination. Block 102 can also optionally be preceded by the user device 520 sending a search query to a map server 530 to find a location or a list of potential locations. In such an implementation, the user device 520 would receive a location or list of potential locations. Once a target destination was selected from the location or list of potential locations, the user device 520 would then request route information to the target destination from the route server 540.

At block 504, the user device 520 can receive the route information from the route server 540 to the target destination. The user device 502 can then use the route information to present navigation to the target destination on a user interface of the user device 502. For example, a client application 206 can present navigation based at least in part on the route information.

At block 506, the user device 520 sends a search query and route metadata to the map server 530 while enroute to the target destination. For example, a search query of “coffee” can be sent to the map server 530. The search query can be indicative of an intent to add an intermediate waypoint to the present navigation of the present route. The route metadata can be indicative of the present navigation of the present route. In some implementations, the route metadata can include a set of latitudes and longitudes associated with the route.

At block 508, the map server 530 can process the search query and route metadata to generate a location or a list of potential locations that are along the route. The map server 530 can process the route metadata to determine the navigation and/or route on the user device 520. The map server 530 can then create a set of bounding boxes along the route which limit search results responsive to the search query to being within a bounding box of the route. The bounding box can be indicative of the maximum distance between a potential location and the route. In some implementations, the bounding box can represent a physical distance from the route. In some implementations, the bounding box can represent a distance from the route associated with a physical distance from the route. In some implementations, the generated location or list of potential locations can be beyond an intermediate waypoint or a destination of the route.

In some implementations, the search query can be used to ascertain the intent of a user. If a search query is entered that would yield results not along the route (as determined by the received route metadata), the list of locations generated by the map server 530 are not limited along the route. For example, if a “coffee in New York” search query was entered while the user device 202 is navigating a route that is not associated with New York, the list of locations generated would not be along the route. Instead, the intent of the user is ascertained as limiting their search query to a particular location regardless of the current route. Similarly, if a search query is for a unique or particular location, the list of locations generated by the map server 530 are not limited to the route. For example, if a “Statue of Liberty” search query was entered while the user device 202 is navigating a route, the list of locations generated would not be along the route. Instead, the intent of the user is ascertained as limiting their search query to a unique location regardless of the current route.

In some implementations, the mode of transportation used associated with the route can be used to determine a list of locations to generate. For example, if the user device has information that the route is being navigated by bike, the list of locations generated can include more nearby locations as compared to if the route was being navigated by car.

In some implementations, specific search queries may be associated with particular limitations on the list of locations. For example, a “gas”, “recharging”, or “ev charging” search query will provide more results closer to the location of the user device. Generally, these specific search queries will be associated with more urgent subjects such as gas, electric vehicle charging, and medical care among others.

In some implementations, the search query is limited to a subset of the route. The route may already be a multipoint route with one or more intermediate waypoints and a target destination. In some implementations, the search query is limited to the part of the route up until the next point on the multipoint route. For example with reference to FIG. 1, if the user device 202 is navigating to an intermediate waypoint 114, the search query will generate a list of locations between the location of the user device 202 and the intermediate waypoint 114. In some implementations, if there are too few results between the location of the user device 202 and the intermediate waypoint 114, the search query will generate a list of locations including any combination of the following: locations behind the user device 202 and locations along the parts of the route previously traveled.

The map server 530 can process the search query in accordance with the set of bounding boxes to generate a list of search results that are along the route. In some implementations, the search query in relation to the first set of bounding boxes may not return enough results. For example, the search query in relation to the first set of bounding boxes may only return ten results. If the list of search results does not include sufficient results, the map server can generate a second set of bounding boxes along the route that are larger. If the list of search results related to this second set of bounding boxes is also insufficient, the map server can generate a third set of bounding boxes which includes bounding boxes along the parts of the route previously traveled. In some implementations, the bounding boxes can include area beyond a destination or an intermediate waypoint to find locations.

The map server 530 can then process the list of search results to create a processed list of search results. Processing the list of search results can include sorting the list of search results. The map server 530 can sort the list of search results according to many criteria, including multiple criteria. Criteria for sorting here can include whether the location corresponding to the search result is open or will likely be open upon arrival. For example, the search results for “coffee” may be processed at 7:55 am and one of the locations corresponding to a search result will open at 8:00 am. Such a result can be sorted to be above closed locations. Such a result can be sorted as equal (in this particular criteria) to locations corresponding to search results that are presently open at 7:55 am. Such a result can be sorted to be above closed locations and below presently open locations. Other criteria can include popularity of the location. Popularity can be ascertained in a variety of ways, such as how often other users have chosen to visit the location based on a similar search query. Popularity can also be ascertained by importing review information from a review service.

Processing the list of search results can include filtering the list of search results down to a subset. For example, the map server may eliminate the bottom four hundred results from a sorted list of search results with five hundred results. In some implementations, a search result’s position along a route can be used to filter the list of search results. In some implementations, the route can be divided up into segments. Some of the route segments can be closer to the user device 520 while others can be farther along the route from the user device 520. For example, the number of route segments can be seven, but can also be configurable to be any number. Each route segment can have an associated quota. As the list of results are processed, locations associated with each route segment can be assigned to a quota until the quota is full. In some implementations, the quota for closer segments may be larger than the quota for further segments. In some implementations, if a quota for a further segment is unfilled those unfilled slots can be given for closer segments to fill.

At block 510, the map server 530 can send the processed list of search results to the route server 540. The map server 530 can also send route metadata associated with the currently navigated route to the route server 540.

The route server 540 can process the route metadata and the processed list of search results to determine detours and associated routing costs and detour metadata for each result of the processed list of search results. The route server 540 can determine the estimated time a detour would take to travel from the navigated route to each search result of the processed list of search results.

At block 512, the route server 540 can send the processed list of search results with associated detours, routing costs and detour metadata to the map server 530. The map server 530 can then process the processed list of search results with associated detours, routing costs and detour metadata to generate a final list of search results. The final list of search results can be generated after the processed list of search results with associated detours, routing costs and detour metadata is sorted and filtered.

The map server 530 can sort the processed list of search results with associated detours, routing costs and detour metadata according to many criteria, including multiple criteria. Criteria for sorting here can include routing cost information such as time or distance to travel from the route to the search result. Other criteria can include whether the search result is open or popularity as described above. Sorting can also be done by how close the search result is to the location of the user device. For example, search results associated with the closest segment of the route can be sorted higher than search results associated with further segments. In some implementations, results that are associated with parts of the route previously traveled are sorted to be lower on the final list of search results.

The map server 530 can filter the list of search results with associated detours, routing costs and detour metadata according to many criteria, including multiple criteria. For example, the map server may eliminate the bottom four hundred results from the list of search results with five hundred results. In some implementations, a search result’s position along a route can be used to filter the list of search results with associated detours, routing costs and detour metadata. As described above, the route may be divided into segments. Some of the route segments can be closer to the user device 520 while others can be farther along the route from the user device 520. Each route segment can have an associated quota. As the list of search results with associated detours, routing costs and detour metadata are processed, locations associated with each route segment can be assigned to a quota until the quota is full. In some implementations, the quota for closer segments may be larger than the quota for further segments. In some implementations, if a quota for a further segment is unfilled those unfilled slots can be given for closer segments to fill.

At block 514, the map server 530 can send a final list of search results with detours and the associated costs and route metadata to the user device 520. At the user device 520, a client application 206 can present the search results with detours and the associated costs and route metadata. A search result can then be chosen and added to the present navigation of the route.

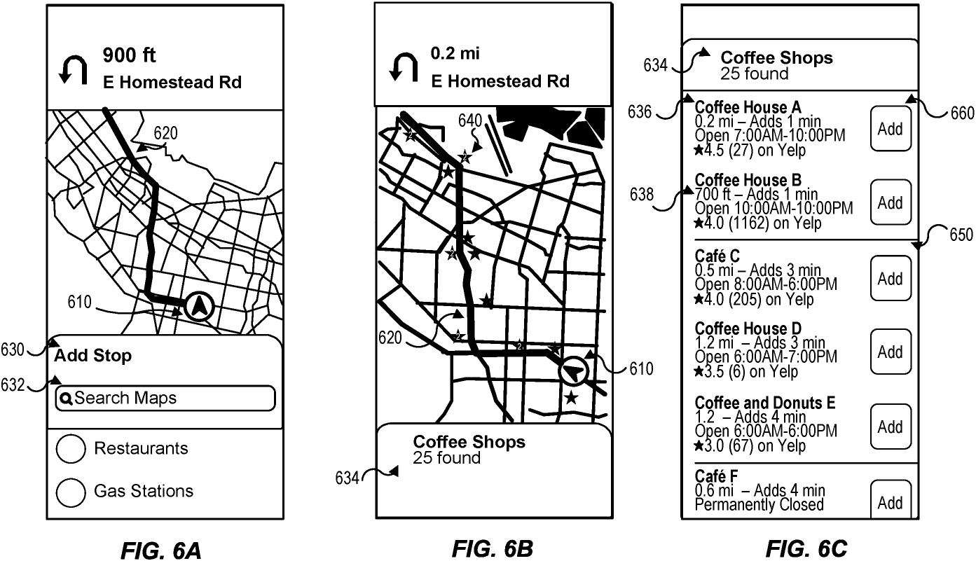

FIGS. 6A, 6B, and 6C illustrate example user interfaces that can be presented on the user device 520 for spatio-temporal distribution of search results. For example, user interfaces similar to FIGS. 6A, 6B, and 6C can be presented during process 500.

FIG. 6A illustrates an example map view and accompanying user elements for entering a search query. The user device location is represented by the user location icon 610. The current route is represented by route 620. The user interface of the user device 520 can present a user interface element for adding an intermediate waypoint. For example, the user interface may have an “add stop” user interface element 630. When the user interface element receives an indication to add an intermediate waypoint, a search bar 632 may appear. A search query can be entered into the search bar 632.

FIG. 6B illustrates an example map view and accompanying user elements for after a search query has been entered and results have been returned. The user interface can present user interface elements for search query locations 640. If more than one user interface elements for search query locations 640 would overlap due to proximity of the search query locations 640, they can be combined and a number can indicate how many search query locations 640 are located approximately at the user interface element for the search query locations. The user interface can also present a list of search query locations 634. In some implementations, the list of search query locations is partially obscured when the map view is shown.

FIG. 6C illustrates an example user interface element for displaying the list of search query locations 634. The list of search query locations 634 can be selected to obscure the map view. Each location 636 on the list of search query locations 634 can be presented. Important information can be included with each location 636 on the list of search query locations 634. For example, each location 636 can include name information, information regarding hours of operation, and reviews indicating popularity. Each location 636 can also include detour cost information 638. The detour cost information can any combination of the following: total roundtrip distance traveled from the current route to the location and back to the current route, one-way distance from the current route to the location, total round trip time added to the route for traveling to the location and back to the current route, one-way time added to the route for traveling from the current route to the location. A location 636 can be added to the current route via the use of a add-to-route user interface element 660.

In some implementations, the list of search query locations 634 can include break user interface elements 650. Break user interface elements 650 can be used to group subsets of the list of search query locations 634 according to various characteristics. Subsets could be based on any combination of the following: detour cost information, reviews indicating popularity, and whether the location is currently open. For example in FIG. 6C, the locations 636 that are open, have a 4.0 or higher rating, and are withing 0.2 miles from the route are above the break user interface element 650. Likewise, a location 636 that is permanently closed is placed below a second break user interface element 650.

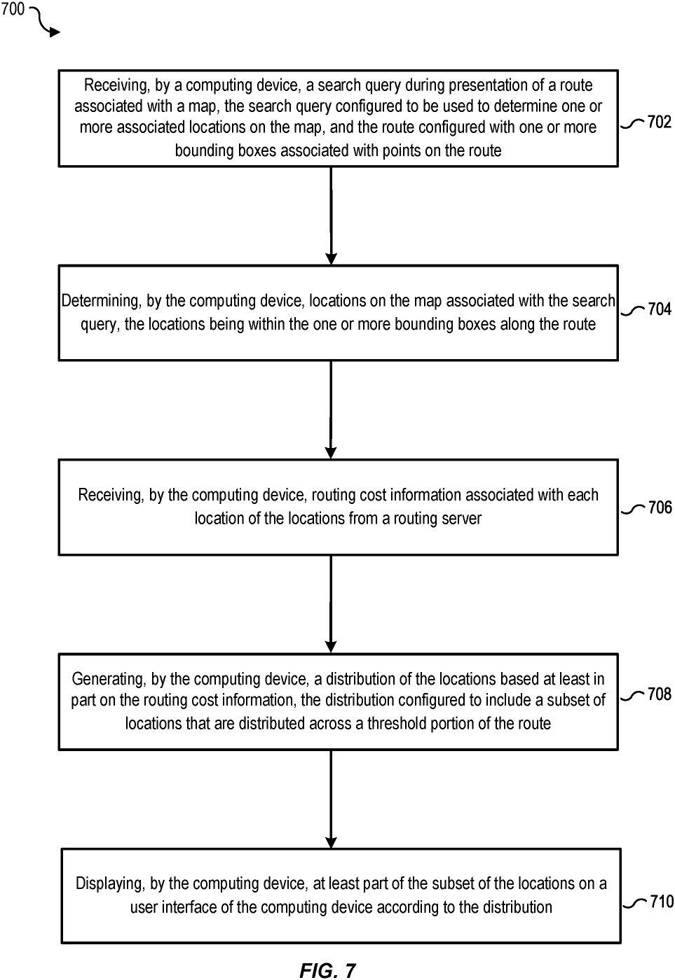

FIG. 7 illustrates a flow chart showing an example process 700 for spatio-temporal distribution of search results, according to at least one example. Process 700 can be performed by a map server 230. Parts of process 700 have corresponding parts of other processes on the user device 202 and the route server 240.

Process 700 is illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The process 700 begins at block 702 by receiving, by a computing device, a search query during presentation of a route associated with a map. The search query can be used to determine one or more associated locations on the map The route can include one or more bounding boxes associated with points on the route.

In some examples, the route can be a multipoint route including one or more intermediate waypoints.

In some examples, the locations on the map can be associated with the search query are further filtered based on context. Context can include a mode of transportation and/or popularity of the location.

At block 704, process 700 includes determining, by the computing device, locations on the map associated with the search query, the locations being within the one or more bounding boxes along the route

In some examples, the locations on the map associated with the search query can correspond to locations between a location associated with a navigation device maintaining and/or guiding navigation of the route and a first intermediate waypoint of the one or more intermediate waypoints.

At block 706, process 700 includes receiving, by the computing device, routing cost information associated with each location of the locations from a routing server

At block 708, process 700 includes generating, by the computing device, a distribution of the locations based at least in part on the routing cost information, the distribution configured to include a subset of locations that are distributed across a threshold portion of the route.

In some examples, the threshold portion of the route can include the whole route. In some examples, the threshold portion of the route can correspond to a portion of the route nearest the navigation device maintaining and/or navigating the route. In some examples, the threshold portion of the route can correspond to a portion of the route between the navigation device and a first intermediate waypoint of the route. In some examples, the threshold portion of the route can correspond to a portion of the route nearest the destination of the route. In some examples, the threshold portion of the route can include areas beyond the destination of the route. For example, the previous destination of the route could become an intermediate waypoint and a new destination can be added to the end of the route.

In some examples, the threshold portion of the route can be divided into a set of segments. The locations can be determined based at least in part on having locations corresponding to each segment of the route.

At block 710, process 700 includes displaying, by the computing device, at least part of the subset of the locations on a user interface of the computing device according to the distribution

In some examples, the locations displayed on the user interface can be sorted based at least in part on the routing cost information.

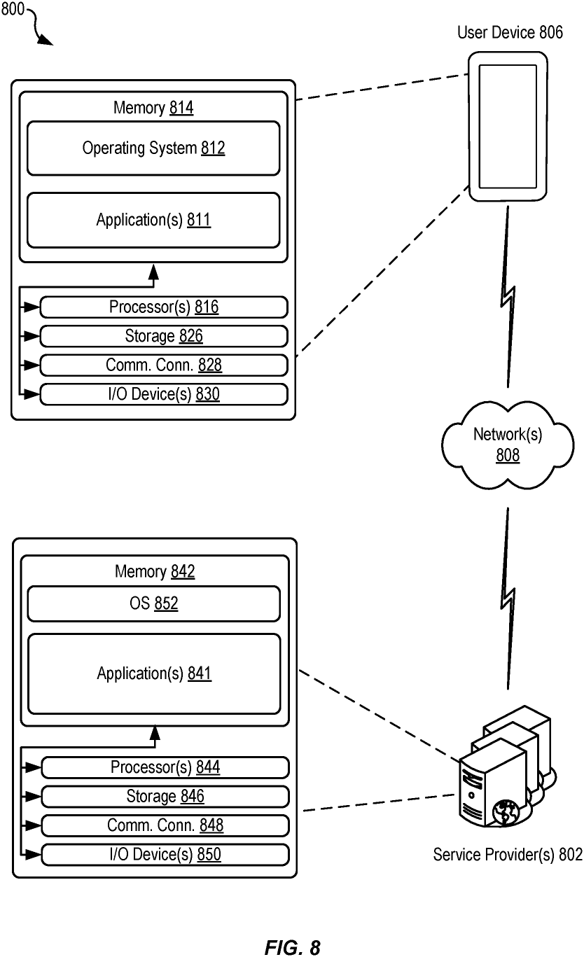

FIG. 8 illustrates an example architecture or environment 800 configured to implement techniques described herein, according to at least one example. The architecture 800 includes a user device 806 (e.g., the user device 204) and a service provider computer 802 (e.g., the service devices 220, 240, 250). In some examples, the example architecture 800 may further be configured to enable the user device 806 and the service provider computer 802 to share information. In some examples, the devices may be connected via one or more networks 808 (e.g., via Bluetooth, WiFi, the Internet). In some examples, the service provider computer 802 may be configured to implement at least some of the techniques described herein with reference to the user device 806 and vice versa.

In some examples, the networks 808 may include any one or a combination of many different types of networks, such as cable networks, the Internet, wireless networks, cellular networks, satellite networks, other private and/or public networks, or any combination thereof. While the illustrated example represents the user device 806 accessing the service provider computer 802 via the networks 808, the described techniques may equally apply in instances where the user device 806 interacts with the service provider computer 802 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 806 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 806 may be in communication with the service provider computer 802 via the network 808, or via other network connections.

In one illustrative configuration, the user device 806 may include at least one memory 814 and one or more processing units (or processor(s)) 816. The processor(s) 816 may be implemented as appropriate in hardware, computer-executable instructions, firmware, or combinations thereof. Computer-executable instructions or firmware implementations of the processor(s) 816 may include computer-executable or machine-executable instructions written in any suitable programming language to perform the various functions described. The user device 806 may also include geo-location devices (e.g., a global positioning system (GPS) device or the like) for providing and/or recording geographic location information associated with the user device 806. In some examples, the processors 816 may include a GPU and a CPU.

The memory 814 may store program instructions that are loadable and executable on the processor(s) 816, as well as data generated during the execution of these programs. Depending on the configuration and type of the user device 806, the memory 814 may be volatile (such as random access memory (RAM)) and/or non-volatile (such as read-only memory (ROM), flash memory). The user device 806 may also include additional removable storage and/or non-removable storage 826 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 814 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 814 and the additional storage 826, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 814 and the additional storage 826 are both examples of non-transitory computer-storage media. Additional types of computer-storage media that may be present in the user device 806 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 806. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 806 may also contain communications connection(s) 828 that allow the user device 806 to communicate with a data store, another computing device or server, user terminals, and/or other devices via the network 808. The user device 806 may also include I/O device(s) 830, such as a keyboard, a mouse, a pen, a voice input device, a touch screen input device, a display, speakers, and a printer.

Turning to the contents of the memory 814 in more detail, the memory 814 may include an operating system 812 and/or one or more application programs or services for implementing the features disclosed herein such as applications 811 (e.g., the map engine 204, client apps 206, health application, digital wallet, third-party applications, browser application, etc.). Applications 811 (e.g., the map engine 204, client applications 206) can perform some or all the techniques (or corresponding techniques) as described with reference to the processes 100, 300, 400, 500, 700. Similarly, at least some techniques described with reference to the service provider computer 802 may be performed by the user device 806.

The service provider computer 802 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 802 may be in communication with the user device 806 via the network 808, or via other network connections.

In one illustrative configuration, the service provider computer 802 may include at least one memory 842 and one or more processing units (or processor(s)) 844. The processor(s) 844 may be implemented as appropriate in hardware, computer-executable instructions, firmware, or combinations thereof. Computer-executable instructions or firmware implementations of the processor(s) 844 may include computer-executable or machine-executable instructions written in any suitable programming language to perform the various functions described.

The memory 842 may store program instructions that are loadable and executable on the processor(s) 844, as well as data generated during the execution of these programs. Depending on the configuration and type of service provider computer 802, the memory 842 may be volatile (such as RAM) and/or non-volatile (such as ROM and flash memory). The service provider computer 802 may also include additional removable storage and/or non-removable storage 846 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 842 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 842 and the additional storage 846, both removable and non-removable, are both additional examples of non-transitory computer-readable storage media.

The service provider computer 802 may also contain communications connection(s) 848 that allow the service provider computer 802 to communicate with a data store, another computing device or server, user terminals, and/or other devices via the network 808. The service provider computer 802 may also include I/O device(s) 850, such as a keyboard, a mouse, a pen, a voice input device, a touch input device, a display, speakers, and a printer.

Turning to the contents of the memory 842 in more detail, the memory 842 may include an operating system 852 and/or one or more application programs 841 or services for implementing the features disclosed herein. For example, the services and applications associated with or corresponding to the map server 222, the route server 242, and map vendor 252 correspond to applications 1041 on the service providers 1002, such that the server devices 220, 240, 250 may include other applications for other features and/or services. Applications 1041 (e.g., the map server 222, the route server 242, and map vendor 252) can perform some or all of the techniques (or corresponding techniques) as described with reference to the processes 100, 300, 400, 500, 700.

The various examples can be further implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java^{®}, C, C# or C++, or any scripting language, such as Perl, Python, or TCL, as well as combinations thereof. The server(s) may also include database servers, including without limitation those commercially available from Oracle^{®}, Microsoft^{®}, Sybase^{®}, and IBM^{®}.

The environment can include a variety of data stores and other memory and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, keypad), and at least one output device (e.g., a display device, printer, speaker). Such a system may also include one or more storage devices, such as disk drives, optical storage devices, and solid-state storage devices such as RAM or ROM, as well as removable media devices, memory cards, flash cards, etc.

Such devices can also include a computer-readable storage media reader, a communications device (e.g., a modem, a network card (wireless or wired), an infrared communication device), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets), or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user’s personal health record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter IDs, home addresses, data or records relating to a user’s health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user’s experience with mapping services. Further, other uses for personal information data that benefit the user are also contemplated by the present disclosure..

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user’s privacy. De-identification may be facilitated, when appropriate, by removing specific identifiers (e.g., date of birth), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1-44. (canceled)

45. A computer-implemented method, comprising:
maintaining, by a user device, navigation to a first intermediate waypoint, the first intermediate waypoint corresponding to a multi-waypoint route on a map, the multi-waypoint route having one or more intermediate waypoints and a destination;
determining, by the user device, whether the user device is within a zone corresponding to the first intermediate waypoint of the multi-waypoint route;
in response to determining that the user device is within the zone corresponding to the first intermediate waypoint, identifying a set of locations of the user device, each location of the set of locations identified at least periodically by the user device;
determining, by the user device, a set of weights for the locations, each weight of the set of weights corresponding to a location of the set of locations, and each weight being based at least in part on a time since the respective locations were identified;
determining, by the user device, a departure score based at least in part on the set of weights and the set of locations;
updating the multi-waypoint route on the map based at least in part on the departure score.

46. The method of claim 45, wherein updating the multi-waypoint route includes maintaining navigation to the first intermediate waypoint based at least in part on the departure score in relation to a departure threshold.

47. The method of claim 45, wherein updating the multi-waypoint route includes advancing navigation from the first intermediate waypoint to a second intermediate waypoint or to the destination based at least in part on the departure score in relation to a departure threshold.

48. The method of claim 45, wherein the zone is a pre-arrival zone.

49. The method of claim 48, wherein the pre-arrival zone is based at least in part on an area having one or more area properties.

50. The method of claim 49, wherein the pre-arrival zone includes an area with an area property of being a parking area associated with the first intermediate waypoint.

51. The method of claim 48, wherein the pre-arrival zone includes an area within a distance of the first intermediate waypoint.

52. The method of claim 48, wherein the pre-arrival zone includes an area within a distance of one or more entries associated with the first intermediate waypoint.

53. The method of claim 48, wherein the pre-arrival zone includes any combination of the following: an area within a distance of the first intermediate waypoint, an area within a distance of an entry associated with the first intermediate waypoint, an area within a distance of one or more entries associated with the first intermediate waypoint, and a parking area associated with the first intermediate waypoint.

54. The method of claim 45, wherein the departure score corresponds, at least in part, to a number of locations of the set of locations inside the zone.

55. The method of claim 45, wherein the departure score corresponds, at least in part, to a ratio of a number of locations of the set of locations inside the zone compared to a total number of locations in the set of locations.

56. The method of claim 45, wherein the departure score corresponds, at least in part, to distances of the locations of the set of locations from the zone.

57. The method of claim 45, wherein the departure score corresponds, at least in part, to distances of the locations of the set of locations from the first intermediate waypoint.

58. A device, comprising:
a memory configured to store computer-executable instructions; and
a processor configured to access the memory and execute the computer-executable instructions to at least:
maintain, by the device, navigation to a first intermediate waypoint, the first intermediate waypoint corresponding to a multi-waypoint route on a map, the multi-waypoint route having one or more intermediate waypoints and a destination;
determine, by the device, whether the device is within a zone corresponding to the first intermediate waypoint of the multi-waypoint route;
in response to determining that the device is within the zone corresponding to the first intermediate waypoint, identify a set of locations of the device, each location of the set of locations identified at least periodically by the device;
determine, by the device, a set of weights for the locations, each weight of the set of weights corresponding to a location of the set of locations, and each weight being based at least in part on a time since the respective locations were identified;
determine, by the device, a departure score based at least in part on the set of weights and the set of locations;
update the multi-waypoint route on the map based at least in part on the departure score.

59. The device of claim 58, wherein the departure score corresponds, at least in part, to an auto-advance tendency factor.

60. The device of claim 58, wherein the departure score corresponds, at least in part, to a number of re-routes to the first intermediate waypoint after the user device entered the zone.

61. One or more non-transitory computer-readable media comprising computer-executable instructions that, when executed by one or more processors of a computer system, cause the computer system to perform operations, comprising:
maintaining, by a user device, navigation to a first intermediate waypoint, the first intermediate waypoint corresponding to a multi-waypoint route on a map, the multi-waypoint route having one or more intermediate waypoints and a destination;
determining, by the user device, whether the user device is within a zone corresponding to the first intermediate waypoint of the multi-waypoint route;
in response to determining that the user device is within the zone corresponding to the first intermediate waypoint, identifying a set of locations of the user device, each location of the set of locations identified at least periodically by the user device;
determining, by the user device, a set of weights for the locations, each weight of the set of weights corresponding to a location of the set of locations, and each weight being based at least in part on a time since the respective locations were identified;
determining, by the user device, a departure score based at least in part on the set of weights and the set of locations;
updating the multi-waypoint route on the map based at least in part on the departure score.

62. The one or more non-transitory computer-readable media of claim 61, wherein the departure score is calculated at least periodically.

63. The one or more non-transitory computer-readable media of claim 61, wherein a period for identifying each location of the set of locations is one second.

64. The one or more non-transitory computer-readable media of claim 61, wherein the set of locations is limited to a maximum number of locations, an oldest location being replaced by a newest location.
